(19) United States
(12) Patent Application Publication
(10) Pub. No.: US 2020/0193500 A1
(43) Pub. Date: Jun. 18, 2020

(54) DATA PROCESSING METHOD AND APPARATUS BASED ON ELECTRONIC COMMERCE

(71) Applicants: BEIJING JINGDONG SHANGKE INFORMATION TECHNOLOGY CO., LTD., Beijing (CN); BEIJING JINGDONG CENTURY TRADING CO., LTD., Beijing (CN)

(72) Inventors: Jianhui CHEN, Beijing (CN); Rongfang SHAO, Beijing (CN); Hui HAO, Beijing (CN); Yani SHI, Beijing (CN); Wenjing XIE, Beijing (CN)

(21) Appl. No.: 16/628,702

(22) PCT Filed: Jul. 4, 2018
(86) PCT No.: PCT/CN2018/094423

§ 371 Date: Jan. 6, 2020

(30) Foreign Application Priority Data
Jul. 4, 2017 (CN) 201710536624.9

(51) Int. Cl. G06Q 30/06; G06F 16/9535; G06F 16/2457; G06F 16/29

(52) U.S. Cl. CPC G06Q 30/0625; G06Q 30/0639; G06F 16/29; G06F 16/24578; G06F 16/9535

(57) ABSTRACT

The embodiments of the present application relate to a data processing method and device based on electronic commerce. The data processing method includes: obtaining data including user searching logs and logistics information; obtaining descending ranks of region-based keyword weights according to the data; obtaining feature values of a keyword in respective regions according to the descending ranks of the region-based keyword weights; and marking a hotspot region corresponding to the keyword according to the feature values.

### CROSS-REFERENCE TO RELATED APPLICATIONS

This application is based upon International Application No. PCT/CN2018/094423, filed on Jul. 4, 2018, which is based upon and claims the priority of the Chinese Patent Application No. 201710536624.9, filed with the Chinese Patent Office on Jul. 4, 2017, the entire contents of which are hereby incorporated by reference.

### TECHNICAL FIELD

The present disclosure relates to the field of data mining technology, and in particular, to a data processing method and device based on electronic commerce.

### BACKGROUND

With the development of electronic commerce (E-commerce) business, a traditional ‘one result for thousands searching’ search and recommendation system has been unable to effectively meet user needs. Moreover, China has a vast territory, and there are large differences in climate, customs, and environment in various regions.

At present, an E-commerce search system displays and ranks all kinds of commodities mainly based on textual relevance of a commodity and user search keywords, a quality of information of the commodity itself, and the like, but does not involve regional characteristics. A commodity recommendation system determines a recommended commodity mainly depending on user's past behavior, platform promotions, manual operation and the like and the regional characteristics are not involved in recommendation factors either. Therefore, in an existing data processing mode, there are often problems such as search results cannot accurately meet the needs of users. For example, most air conditioners in the north of China require having heating and cooling modes, while most areas in the south of China only require cooling mode. When users in the north of China search for air conditioners, it is difficult to require the search results that accurately match their needs. In addition, recommendations that do not involve regional characteristics will also result in loss of traffic conversion and even cause user's resentment. For example, anti-fog masks were sold well in the north in a certain period, but the recommendation system recommended these commodities to users in Hainan and other places in the south of China. For the last one, search and recommendation systems that do not involve regional characteristics are ‘powerless’ for the local specialty commodities, clothing and other high regional sales during local traditional holidays.

Therefore, there is a need for a data processing method that can mine the regional characteristics of commodities.

It should he noted that the information disclosed in the background section above is only used to enhance the understanding of the background of the disclosure, and therefore may include information that does not constitute the prior art known to those of ordinary skill in the art.

### SUMMARY

According to a first aspect of embodiments of the present disclosure, there is provided a data processing method based on electronic commerce, including: obtaining data including user searching logs and logistics information; obtaining descending ranks of region-based keyword weights according to the data; obtaining feature values of a keyword in respective regions according to the descending ranks of the region-based keyword weights; and marking a hotspot region corresponding to the keyword according to the feature values.

In an exemplary embodiment of the present disclosure, the obtaining descending ranks of region-based keyword weights according to the data includes: obtaining a region-based keyword searching page-view (PV) according to the user searching logs; obtaining a number of a region-based keyword-corresponding commodity according to the logistics information; determining, for a region, a sum of a product of the region-based keyword-searching PV with a first coefficient and a product of the number of the region-based keyword-corresponding commodity with a second coefficient as a weight of the keyword in the region; and removing the keyword with the weight lower than a threshold, and performing a region-based descending ranking on the keyword according to the weights.

In an exemplary embodiment of the present disclosure, the obtaining feature values of a keyword in respective regions according to the descending ranks of the region-based keyword weights includes: obtaining descending ranks of total weights of regions; obtaining descending ranks of the weights of the keyword in all the regions; obtaining, for each of the regions, the keyword with the weight not only in top N ranks in the each of the regions but also in top xN ranks in all the regions, where N is a natural number and x is an expansion coefficient; and calculating, for each of the keywords and each of the regions, the feature value as: (the weight of the keyword in the region/the total weight of the region)*(a number of total regions/a number of regions in which the keyword is in top N ranks).

In an exemplary embodiment of the present disclosure, the marking a hotspot region corresponding to the keyword according to the feature values includes: obtaining variances of the feature values of the keyword in the respective regions; removing a region with the variance less than a threshold, and obtaining descending ranks of the variances in remaining regions; and marking the hotspot region corresponding to the keyword according to the descending rankings of the variances.

In an exemplary embodiment of the present disclosure, the obtaining data includes removing crawler data, blacklisted user data, blacklisted IP data, data whose source being undetermined, and a long-tail keyword from the data.

According to an aspect of the present disclosure, there is provided a data processing device based on electronic commerce, including: a data cleaning module configured to obtain data including user searching logs and logistics information; a data integration module configured to obtain descending ranks of region-based keyword weights according to the data; a data calculation module configured to obtain feature values of a keyword in respective regions according to the descending ranks of the region-based keyword weights; and a data marking module configured to mark a hotspot region corresponding to the keyword according to the feature values.

In an exemplary embodiment of the present disclosure, the data integration module includes: an element obtaining unit configured to obtain a region-based keyword searching page-view (PV) according to the user searching logs, and obtain a number of a region-based keyword-corresponding commodity according to the logistics information; a. weight calculation unit configured to determine, for a region, a sum of a product of the region-based keyword-searching PV with a first coefficient and a product of the number of the region-based keyword-corresponding commodity with a second coefficient as a weight of the keyword in the region; and a weight ranking unit configured to remove the keyword with the weight lower than a threshold, and perform a region-based descending ranking on the keyword according to the weights.

In an exemplary embodiment of the present disclosure, the data calculation module includes: a first weight calculation unit configured to obtain descending ranks of total weights of regions; a second weight calculation unit configured to obtain descending ranks of the weights of the keyword in all the regions; a keyword filtering unit configured to obtain, for each of the regions, the keyword with the weight not only in top N ranks in the each of the regions but also in top xN ranks in all the regions, where N is a natural number and x is an expansion coefficient; and a calculation unit configured to calculate, for each of the keywords and each of the regions, the feature value as: (the weight of the keyword in the region/the total weight of the region)*(a number of total regions/a number of regions in which the keyword is in top N ranks).

In an exemplary embodiment of the present disclosure, the data marking module includes: a variance calculation unit configured to obtain variances of the feature values of the keyword in the respective regions; a region ranking unit configured to remove a region with the variance less than a threshold, and obtaining descending ranks of the variances in remaining regions; a region marking unit configured to mark the hotspot region corresponding to the keyword according to the descending rankings of the variances.

In an exemplary embodiment of the present disclosure, the data cleaning module is configured to remove crawler data, blacklisted user data, blacklisted IF data, data whose source being undetermined, and a long-tail keyword from the data.

According to an aspect of the present disclosure, there is provided a computer-readable storage medium having a computer program stored thereon, when the computer program is executed by a processor, steps of the method according to any one of the above are carried out.

According to an aspect of the present disclosure, there is provided an electronic apparatus including a memory and a processor coupled to the memory, the processor is configured to execute the method according to any one of the above based on instructions stored in the memory.

It should be understood that the above general description and the following detailed description are merely exemplary and explanatory, and should not limit the present disclosure.

### BRIEF DESCRIPTION OF THE DRAWINGS

The drawings herein are incorporated in and constitute a part of this specification, illustrate embodiments consistent with the present disclosure and together with the description serve to explain the principles of the present disclosure. Obviously, the drawings in the following description are just some embodiments of the present disclosure. For those of ordinary skill in the art, other drawings can be obtained according to these drawings without creative efforts.

FIG. 1 schematically illustrates a flowchart of a data processing method in an exemplary embodiment of the present disclosure.

FIG 2 schematically illustrates a sub-flowchart of step S104 in the data processing method 100 in an exemplary embodiment of the present disclosure.

FIG. 3 schematically illustrates a sub-flowchart of step S106 in the data processing method 100 in an exemplary embodiment of the present disclosure.

FIG 4 schematically illustrates a sub-flowchart of step S108 in the data processing method 100 in an exemplary embodiment of the present disclosure.

FIG. 5 schematically illustrates a block diagram of a data processing device in an exemplary embodiment of the present disclosure.

FIG. 6 is a schematic diagram illustrating a workflow of a data processing device in an exemplary embodiment of the present disclosure.

FIG 7 schematically illustrates a block diagram of another data processing device in an exemplary embodiment of the present disclosure.

### DETAILED DESCRIPTION

Example embodiments will now be described more fully with reference to the accompanying drawings. However, the exemplary embodiments can be implemented in various forms and should not be construed as being limited to the examples set forth herein. Rather, these embodiments are provided so that this disclosure will be thorough and complete, and will fully convey the concept of example embodiments to those skilled in the art. The described features, structures, or characteristics may be combined in any suitable manner in one or more embodiments, in the following description, numerous specific details are provided to give a full understanding of the embodiments of the present disclosure. However, those skilled in the art will realize that the technical solutions of the present disclosure may be practiced without one or more of the specific details, or other methods, components, devices, steps, etc. may be adopted. In other cases, well-known technical solutions are not shown or described in detail to avoid obsession and obscure aspects of the present disclosure.

In addition, the drawings are merely schematic illustrations of the present disclosure, and the same reference numerals in the drawings indicate the same or similar parts, and thus repeated descriptions thereof will be omitted. Some block diagrams shown in the drawings are functional entities and do not necessarily have to correspond to physically or logically independent entities. These functional entities may be implemented in the form of software, or implemented in one or more hardware modules or integrated circuits, or implemented in different networks and/or processor devices and/or microcontroller devices.

The exemplary embodiments of the present disclosure will be described in detail below with reference to the drawings.

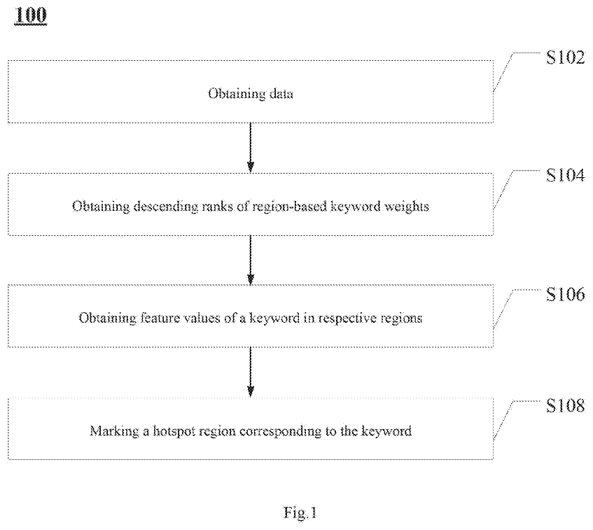

FIG. 1 schematically illustrates a flowchart of a data processing method in an exemplary embodiment of the present disclosure.

Referring to FIG. 1, a data processing method 100 may include: at step S102, obtaining data including user searching logs and logistics information; at step 104, obtaining descending ranks of region-based keyword weights according to the data; at step 106, obtaining feature values of a keyword in respective regions according to the descending ranks of the region-based keyword weights; and at step 108, marking a hotspot region corresponding to the keyword according to the feature values.

The data processing method 100 mainly involves processes such as data cleaning, data integration, keyword regional feature value calculation, and keyword image. An entire computing process uses a distributed computing framework, which can improve massive data processing capacity and data computing timeliness.

The data processing method and device provided by the present disclosure process search behavior and logistics information through data cleaning, integration, feature value calculation, hotspot region marking, etc., which can truly and accurately mine a regional characteristic of a keyword, generate a regional characteristic image of the keyword, and ensure timeliness of mined data through data scrolling, thereby providing data support for search recommendation and other services, which will help build a ‘thousands results for thousands searching’ search recommendation system which is personalized.

Each step of the data processing method 100 is described in detail below.

At step S102, the obtaining data including user searching logs and logistics information data includes obtaining data from data warehouse, and also includes obtaining data from system real-time log stream information and real-time logistics information. The step S102 may also be referred to as a data cleaning step. In this step, input data includes user searching logs and logistics information, and output data includes legal searching logs and logistics information. The process of cleaning data can include removing crawler data, removing blacklisted user ID data, removing blacklisted IP data, removing the data whose source cannot be determined, and removing a long tail keyword. Among them, the long-tail keyword is a keyword whose search frequency is lower than a threshold and whose search volume fluctuates greatly. The sequence and content of the above data cleaning process are only exemplary, and those skilled in the art may clean and organize data. according to actual conditions.

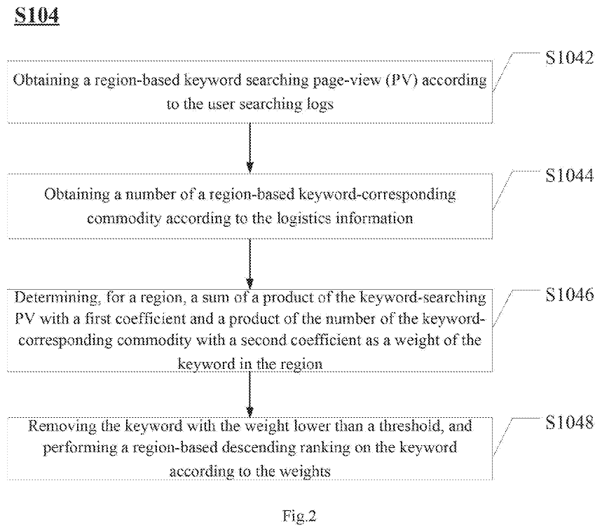

FIG. 2 schematically illustrates a sub-flowchart of step S104 in the data processing method 100 in an exemplary embodiment of the present disclosure.

Referring to FIG. 2, the step S104 includes: at step S1042, obtaining a region-based keyword searching page-view (PV) according to the user searching logs; at step S1044, obtaining a number of a region-based keyword-corresponding commodity according to the logistics information; at step S1046, determining, for a region, a sum of a product of the region-based keyword-searching PV with a first coefficient and a product of the number of the region-based keyword-corresponding commodity with a second coefficient as a weight of the keyword in the region; and at step S1048, removing the keyword with the weight lower than a threshold, and performing a region-based descending ranking on the keyword according to the weights.

The step S104 may be referred to as a data integration step. In this step, input data is the searching log and logistics information data outputted in step S104, and output data is ranks of region-based keyword weights, for example, a table in the format of key word-region-weigh t- sequence number.

In step S1042, a list in the format of keyword-region-searching PV can be obtained from the searching logs. The list can indicate the searching quantity for a commodity category in a region.

The searching PV (page-view) is the number of times a user searches for a keyword using a search interface, and there is one PV each time the user uses the search interface. The region refers to the region where the user IP is located based on the user searching logs. The region can be classified by country, area, and administrative province, or by other classifications that can be used to distinguish regions, and the present disclosure is not limited thereto. However, it can be understood that the “region” mentioned in the present disclosure remains the same classification method no matter Which classification method is followed,

In step S1044, a list in the format of keyword-region-commodity number can be obtained from the logistics information. The list can indicate an actual purchase quantity of a commodity category in a region.

In step S1046, the results of step S1042 and step S1044 can be proportionally unioned. It determines, for a region, a sum of a product of the keyword-searching PV with a first coefficient and a product of the number of the keyword-corresponding commodity with a second coefficient as a weight of the keyword in the region, and a list in the format of keyword-region-weight is output. The above first coefficient and second coefficient may be equal or different, which is not specifically limited in the present disclosure. For example, when the searching PV of the keyword “towel” in the region ‘Beijing’ is 10000, and the number of ‘towels’ shipped to ‘Beijing’ is 1000, the first coefficient can be set to 0.2 and the second coefficient can be set to 0.8, thus the weight of the keyword ‘towel’ in the region ‘Beijing’ is 10000*0.2+1000*0.8=2800. The purpose of setting the first coefficient and the second coefficient is to adjust the weight of the commodity according to the search-purchase ratio between different commodities. For example, the search-purchase ratio of ‘clothing’ is often significantly larger than the search-purchase ratio of ‘refrigerator’. At this time, the actual weight of the commodity can be more accurately reflected by adjusting the search-purchase ratio of each product via setting coefficients.

In step S1048, firstly, the data whose weight is lower than a threshold needs to be removed, so that there is no need to perform statistics on the commodity with low attention. The value of the threshold can be set freely. Secondly, it can perform a descending ranking of the weights according to the list outputted in step S1046, and output a list in the format of keyword-region-weight-sequence number.

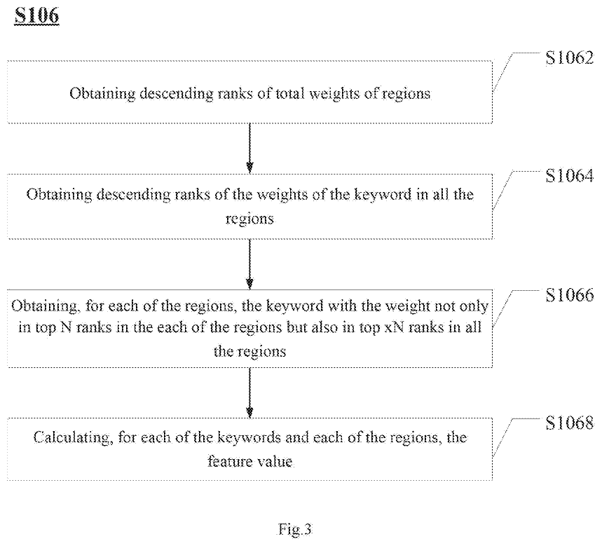

FIG. 3 schematically illustrates a sub-flowchart of step S106 in the data processing method 100 in an exemplary embodiment of the present disclosure.

Referring to FIG. 3, the step S106 includes: at step S1062, obtaining descending ranks of total weights of regions; at step S1064, obtaining descendimg ranks of the weights of the keyword in all the regions; at step S1066, obtaining, for each of the regions, the keyword with the weight not only in top N ranks in the each of the regions but also in top xN ranks in all the regions, where N is a natural number and x is an expansion coefficient; and at step S1068, calculating, for each of the keywords and each of the regions, the feature value as: (the weight of the keyword in the region/the total weight of the region)*(a number of total regions/a number of regions in which the keyword is in top N ranks).

The input data in step S106 is the keyword-region-weight-sequence data outputted in step S104, and the output data in step 106 is a list in the format of key word-region-weigh t-TF-IDF value.

In step S1062, a total weight of each of the regions based on all the keywords is obtained, and a list in the format of region-weight is output.

In step S1064, a total weight of each of the keywords based on all the regions is obtained, descending ranks of the total weights of the respective keywords are obtained, and a list in the format of keyword-weight-sequence number is output.

In step S1066, firstly, the keywords in the top N ranks can be obtained for each region, and a list in the format of keyword-region-weight is output. Then, the keywords in the top xN ranks of all the regions is obtained according to the list outputted in step S1064, and a list in the format of keyword-weight is output, wherein N is a natural number and x is an expansion coefficient. In some embodiments, x may be equal to 10, for example. After obtaining the above two lists, an intersection thereof are taken. Therefore for each ration, the keywords with the weight not only in top N ranks in the each region but also in top xN ranks in all the regions are obtained, and a list in the format of keyword-region-weight is output.

Through further filtering, keywords that are more regional representative can be obtained, thereby improving data processing efficiency.

In step S1066, the feature value of each keyword in each region is calculated according to the output results of steps S1062 to S1064.

In an exemplary embodiment of t sent disclosure, the above-mentioned feature value may be a TF-IDF value.

The TF-IDF value refers to TF*IDF. TF (Term Frequency) indicates a frequency at which an entry t appears in a document d. IDF (Inverse Document Frequency) indicates that the fewer documents containing the entry t, the stronger capacity of the category discrimination about the entry t.

In an embodiment of the present disclosure, the formula for calculating the TF-IDF value may be set as follows:

(a weight of a keyword in a region/a total weight of the region)*(a number of total regions/a number of regions in which the keyword is in top N ranks) (1).

The regions and keywords involved in the above formula are the regions and keywords existing in the output list of step SI064. The weight of the keyword in the region is the total weight of the keyword in the region obtained from the keyword-region-weight-sequence number list data outputted in step S104; the data regarding the total weight of the region is obtained from the list of region-weight outputted in step S1062; the number of total regions is the number of regions obtained from the keyword-region-weight-sequence number data outputted in step S104, or the number of regions obtained according to system settings; the number of regions in which the keyword is in top N ranks is the number of regions associated with the keyword, which is obtained from the keyword-region-weight list outputted in step S1066.

The ratio of the weight of the keyword in the region to the total weight of the region can indicate the frequency of occurrence of the keyword in the region, and the larger the ratio is, the more frequently the keyword appears in the region. The ratio of the number of total regions to the number of regions in which the keyword is in top N ranks can indicate whether the frequency of occurrence of the keyword is regional specific, and the larger the ratio is, the more regional specific the keyword appears in the region. Therefore, it can be known from formula (1) that the higher the frequency of occurrence and the greater the specificity of the region, the higher the TF-IDF value of the keyword is, that is, the more obvious the regional characteristics of the region is.

After calculation, a list in the format of keyword-region-weight-TF-IDF value is outputted from step S1066. By using the TF-IDF algorithm to calculate region characteristics of keywords, the effect of the magnitude of absolute data in each region can be effectively avoided, and the calculation results of this method are more accurate.

In other exemplary embodiments of the present disclosure, the TF-IDF algorithm may also be replaced by an algorithm such as a space vector cosine algorithm, as long as a technical solution for implementing the method using an algorithm that calculates significant features of keywords is within the protection scope of the present disclosure.

FIG, 4 schematically illustrates a sub-flowchart of step S108 in the data processing method 100 in an exemplary embodiment of the present disclosure.

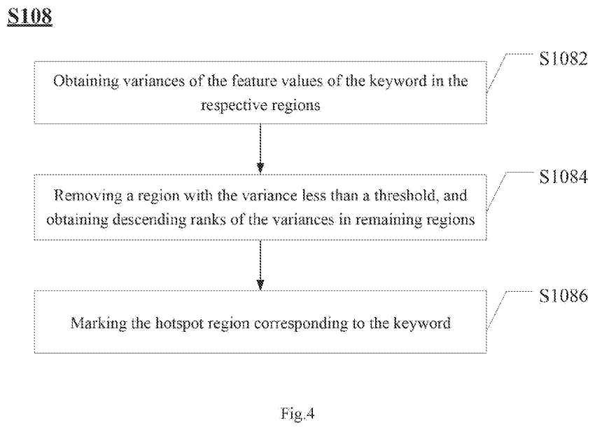

Referring to FIG. 4, the step S108 includes: at step S1082, obtaining variances of the feature values of the keyword in the respective regions; at step S1084, removing a region with the variance less than a threshold, and obtaining descending ranks of the variances in remaining regions; and at step S1086, marking the hotspot region corresponding to the keyword according to the descending rankings of the variances.

The input data of step S108 is the keyword-region-weight-feature value list outputted in step S1066, and a list in the format of keyword-hotspot region, hotspot region 2 . . . region N.

In step S1082, the variances of the feature values of the keyword in different regions are obtained. The main purpose of this step is to determine whether the regional characteristic of the keyword in a region is significantly different from an average value.

In step S1084, the respective variances are processed. Firstly, the region whose variance is less than a threshold is removed, that is, the region with the regional characteristic close to the average value is removed. The setting of the above threshold can be adjusted according to actual conditions. Next, descending ranks of the variances in remaining regions are obtained.

In step S1086, the keywords are marked with hotspot regions according to the descending rankings of the variances. The hotspot region means the region with obvious regional characteristic. The number of hotspot regions can be limited, or regions with variances above the threshold can be marked out, and those skilled in the art can set them according to actual conditions.

Step S108 can be repeated to make each keyword to be marked with corresponding hotspot regions. The marking results can be showed in the form of data charts, maps, etc., and can also be used as internal data to provide data support for search, recommendation, and advertising systems.

In summary, the data processing method 100 processes search behavior and logistics information through data cleaning, integration, feature value calculation, hotspot region marking, etc., which can truly and accurately mine a regional characteristic of a keyword, generate a regional characteristic image of the keyword, and ensure timeliness of mined data through data scrolling, thereby providing data support for search recommendation and other services, which will help build a ‘thousands results for thousands searching’ search recommendation system which is personalized.

The present disclosure also provides a data processing device corresponding to the above method embodiments, which can be used to execute the above method embodiments.

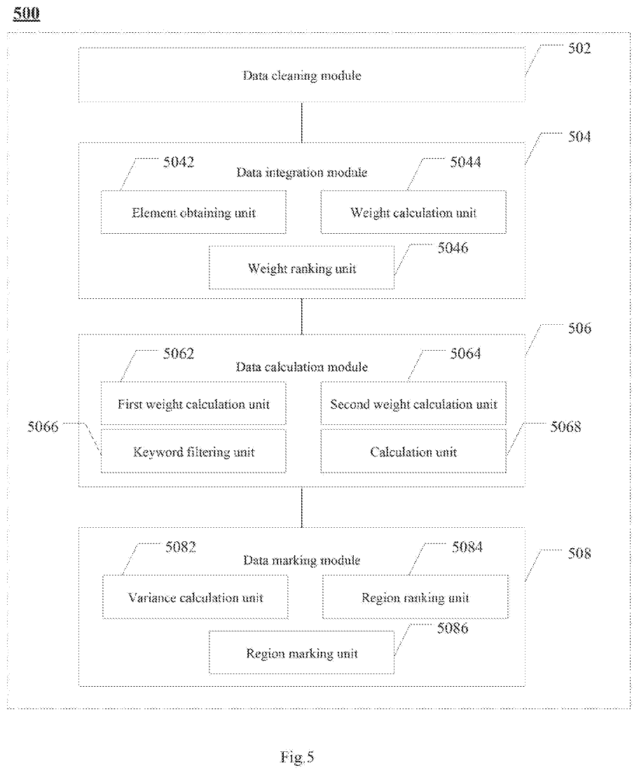

FIG 5 schematically illustrates a block diagram of a data processing device in an exemplary embodiment of the present disclosure.

Referring to FIG. 5, a data processing device 500 may include a data cleaning module 502 configured to obtain data including user searching logs and logistics information; a data integration module 502 configured to obtain descending ranks of region-based keyword weights according to the data; a data calculation module 506 configured to obtain feature values of a keyword in respective regions according to the descending ranks of the region-based keyword weights; and a data marking module 508 configured to mark a hotspot region corresponding to the keyword according to the feature values.

In an exemplary embodiment of the present disclosure, the data cleaning module 502 is configured to remove crawler data, blacklisted user data, blacklisted IP data, data whose source cannot be determined, and a long-tail keyword from the data.

In an exemplary embodiment of the present disclosure, the data integration module 504 includes an element obtaining unit 5042 configured to obtain a region-based keyword searching page-view (PV) according to the user searching logs, and obtain a number of a region-based keyword-corresponding commodity according to the logistics information; a weight calculation unit 5044 configured to determine, for a region, a sum of a product of the region-based keyword-searching PV with a first coefficient and a product of the number of the region-based keyword-corresponding commodity with a second coefficient as a weight of the keyword in the region; and a weight ranking unit 5046 configured to remove the keyword with the weight lower than a threshold, and perform a region-based descending ranking on the keyword according to the weights.

In an exemplary embodiment of the present disclosure, the data calculation module 506 includes a first weight calculation unit 5062 configured to obtain descending ranks of total weights of regions; a second weight calculation unit 5064 configured to obtain descending ranks of the weights of the keyword in all the regions; a keyword filtering unit 5066 configured to obtain, for each of the regions, the keyword with the weight not only in top N ranks in the each of the regions but also in top xN ranks in all the regions, where N is a natural number and x is an expansion coefficient; and a calculation unit 5068 configured to calculate, for each of the keywords and each of the regions, the feature value as: (the weight of the keyword in the region/the total weight of the region)*(a number of all the regions/a number of regions in which the keyword is in top N ranks).

In an exemplary embodiment of the present disclosure, the data marking module 508 includes a variance calculation unit 5082 configured to obtain variances of the feature values of the keyword in the respective regions; a region ranking unit 5084 configured to remove a region with the variance less than a threshold, and obtaining descending ranks of the variances in remaining regions; a region marking unit 5086 configured to mark the hotspot region corresponding to the keyword according to the descending rankings of the variances.

Since the functions of the device 500 have been described in detail in the corresponding method embodiments, the present disclosure will not describe them again for simplicity.

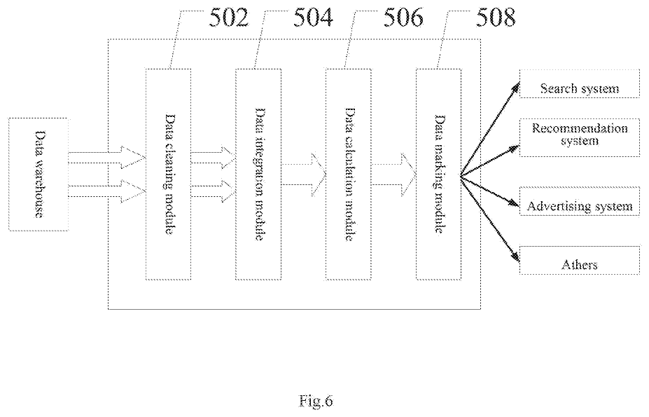

FIG. 6 is a schematic diagram illustrating a workflow of the data processing device 500 in an exemplary embodiment of the present disclosure.

Referring to FIG. 6, the data cleaning module obtains search behavior data and logistics information data from a data warehouse, and sends filtered data to the data integration module 504. The data integration module 504 obtains a list of region-based keyword weights by integrating the filtered search behavior data and logistics information data, and outputs the list to the data calculation module 506. The data calculation module 506 calculates the feature value of the region corresponding to the keyword according to the list, and outputs the calculation results to the data marking module 508. The data marking module 508 marks the corresponding hotspot regions for respective keywords outputted by the data calculation module 506, and sends the marking results to a search system, recommendation system, advertising system, and other systems as data support.

According to an aspect of the present disclosure, there is provided a data processing device, including a memory and a processor coupled to the memory. The processor is configured to execute any one of the above methods based on instructions stored in the memory.

The specific manner in which the processor of the device in this embodiment performs operations has been described in detail in the embodiment of the data processing method, and will not be described in detail here.

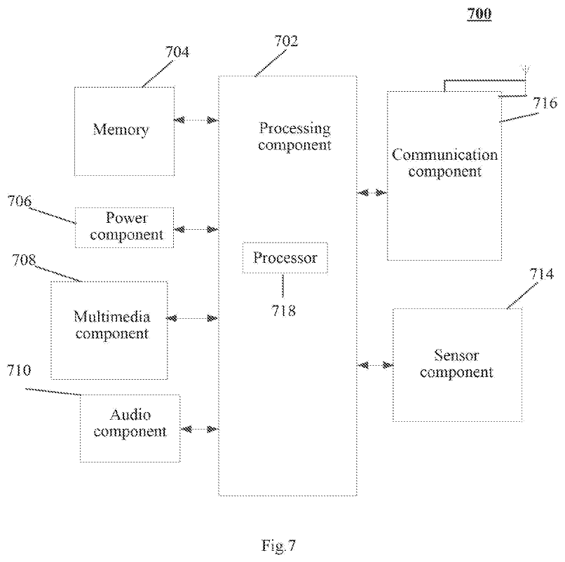

FIG. 7 is a block diagram of a device 700 according to an exemplary embodiment. The device 700 may be a mobile terminal such as a smart phone or a tablet computer, and so on.

Referring to FIG. 7, the device 700 may include one or more of the following components: a processing component 702, a memory 704, a power component 706, a multimedia component 708, an audio component 710, a sensor component 714, and a communication component 716.

The processing component 702 generally controls overall operations of the device 700, such as operations associated with display, telephone calls, data communications, camera operations, and recording operations. The processing component 702 may include one or more processors 718 to execute instructions to complete all or part of the steps of the method described above. In addition, the processing component 702 may include one or more modules to facilitate the interaction between the processing component 702 and other components. For example, the processing component 702 may include a multimedia module to facilitate the interaction between the multimedia component 708 and the processing component 702.

The memory 704 is configured to store various types of data to support operation at the device 700. Examples of such data include instructions for any application program or method operating on the device 700. The memory 704 may be implemented by any type of volatile or non-volatile storage devices or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk. The memory 704 also stores one or more modules, which are configured to be executed by the one or more processors 718 to complete all or part of the steps in any one of the methods shown above.

The power component 706 provides power to various components of the device 700. The power component 706 may include a power management system, one or more power sources, and other components associated with generating, managing, and distributing power for the device 700.

The multimedia component 708 includes a display screen that provides an output interface between the device 700 and a user. In some embodiments, the display screen may include a liquid crystal display (LCD) and a touch panel (TP). If the display screen includes a touch panel, the display screen may be implemented as a touch screen to receive an input signal from a user. The touch panel includes one or more touch sensors to sense touch, swipe, and gestures on the touch panel. A touch sensor can not only sense the boundaries of a touch or slide gesture, but also detect the duration and pressure associated with the touch or slide gesture.

The audio component 710 is configured to output and/or input audio signals. For example, the audio component 710 includes a microphone (MIC). When the device 700 is in an operation mode, such as a call mode, a recording mode, and a voice recognition mode, the microphone is configured to receive an external audio signal. The received audio signal may be further stored in the memory 704 or transmitted via the communication component 716. In some embodiments, the audio component 710 further includes a speaker for outputting an audio signal.

The sensor component 714 includes one or more sensors for providing status assessment of various aspects of the device 700. For example, the sensor component 714 can detect the on/off state of the device 700, the relative positioning of the components, and the sensor component 714 can also detect the change in the position of the device 700 or a component of the device 700 and the temperature change of the device 700. In some embodiments, the sensor component 714 may further include a magnetic sensor, a pressure sensor, or a temperature sensor.

The communication component 716 is configured to facilitate wired or wireless communication between the device 700 and other devices. The device 700 may access a wireless network based on a communication standard, such as WiFi, 2G or 3G or a combination thereof. In one exemplary embodiment, the communication component 716 receives a broadcast signal or broadcast-related information from an external broadcast management system via a broadcast channel. In one exemplary embodiment, the communication component 716 further includes a near field communication (NFC) module to facilitate short-range communication. For example, the NFC module can be implemented based on radio frequency identification (RFID) technology, infrared data association (IrDA) technology, ultra wideband (UWB) technology, Bluetooth (BT) technology and other technologies.

In an exemplary embodiment, the device 700 may be implemented by one or more application-specific integrated circuits (ASICs), digital signal processors (DSPs), digital signal processing devices (DSPDs), programmable logic devices (PLDs), field. programmable gate array (FPGA), controller, microcontroller, microprocessor, or other electronic component implementation, which are used to perform the above method.

In an exemplary embodiment of the present disclosure, there is also provided a computer-readable storage medium on which a program is stored, and when the program is executed by a processor, any of the data processing methods as described above is implemented. The computer-readable storage medium may be, for example, temporary and non-transitory computer-readable storage media including instructions.

Those skilled in the art will readily conceive of other embodiments of the present disclosure after considering the specification and practicing the invention disclosed herein. This application is intended to cover any variations, uses, or adaptations of this disclosure that conform to the general principles of this disclosure and include the common general knowledge or conventional technical means in the technical field not disclosed in this disclosure. It is intended that the specification and examples be considered as exemplary only, with a true scope and spirit of the disclosure being indicated by the following claims.

### INDUSTRIAL APPLICABILITY

The data processing method and device provided by the present disclosure process search behavior and logistics information through data cleaning, integration, feature value calculation, hotspot region marking, etc., which can truly and accurately mine a regional characteristic of a keyword, generate a regional characteristic image of the keyword, and ensure timeliness of mined data through data scrolling, thereby providing data support for search recommendation and other services, which will help build a ‘thousands results for thousands searching’ search recommendation system which is personalized.

What is claimed is:

1. A data processing method based on electronic commerce, comprising:
obtaining data comprising user searching logs and logistics information;
obtaining descending ranks of region-based keyword weights according to the data;
obtaining feature values of a keyword in respective regions according to the descending ranks of the region-based keyword weights; and
marking a hotspot region corresponding to the keyword according to the feature values.

2. The data processing method according to claim 1, wherein the obtaining descending ranks of region-based keyword weights according to the data comprises:
obtaining a region-based keyword searching page-view (PV) according to the user searching logs;
obtaining a number of a region-based keyword-corresponding commodity according to the logistics information;
determining, for a region, a sum of a product of the region-based keyword-searching PV with a first coefficient and a product of the number of the region-based keyword-corresponding commodity with a second coefficient as a weight of the keyword in the region; and
removing the keyword with the weight lower than a threshold, and performing a region-based descending ranking on the keyword according to the weights.

3. The data processing method according to claim 1, wherein the obtaining feature values of a keyword in respective regions according to the descending ranks of the region-based keyword weights comprises:
obtaining descending ranks of total weights of regions;
obtaining descending ranks of the weights of the keyword in all the regions;
obtaining, for each of the regions, the keyword with the weight not only in top N ranks in the each of the regions but also in top xN ranks in all the regions, where N is a natural number and x is an expansion coefficient; and
calculating, for each of the keywords and each of the regions, the feature value as:
(the weight of the keyword in the region/the total weight of the region)*(a number of total regions/a number of regions in which the keyword is in top N ranks).

4. The data processing method according to claim 1, wherein the marking a hotspot region corresponding to the keyword according to the feature values comprises:
obtaining variances of the feature values of the keyword in the respective regions;
removing a region with the variance less than a threshold, and obtaining descending ranks of the variances in remaining regions; and
marking the hotspot region corresponding to the keyword according to the descending rankings of the variances.

5. The data processing method according to claim 1, wherein the obtaining data comprises removing crawler data, blacklisted user data, blacklisted IP data, data whose source being undetermined, and a long-tail keyword from the data.

6-10. (canceled)

11. A computer-readable storage medium having a computer program stored thereon, when the computer program is executed by a processor, steps of a data processing method are carried out, wherein the data processing method comprises:
obtaining data comprising method comprises:
obtaining descending ranks of region-based keyword weights according to the data;
obtaining feature values of a keyword in respective regions according to the descending ranks of the region-based keyword weights; and
marking a hotspot region corresponding to the key word according to the feature values.

12. The computer-readable storage medium according to claim 11, wherein the obtaining descending ranks of region-based keyword weights according to the data comprises:
obtaining a region-based keyword searching page-view (PV) according to the user searching logs;
obtaining a number of a region-based keyword-corresponding commodity according to the logistics information;
determining, for a region, a sum of a product of the region-based keyword-searching PV with a first coefficient and a product of the number of the region-based keyword-corresponding commodity with a second coefficient as a weight of the keyword in the region; and
removing the keyword with the weight lower than a threshold, and performing a region-based descending ranking on the keyword according to the weights.

13. The computer-readable storage medium according to claim 11, wherein the obtaining feature values of a keyword in respective regions according to the descending ranks of the region-based keyword weights comprises:
obtaining descending ranks of total weights of regions;
obtaining descending ranks of the weights of the keyword in all the regions;
obtaining, for each of the regions, the keyword with the weight not only in top N ranks in the each of the regions but also in top xN ranks in all the regions, where N is a natural number and x is an expansion coefficient; and
calculating, for each of the keywords and each of the regions, the feature value as:
(the weight of the keyword in the region/the total weight of the region) * (a number of total regions/a number of regions in which the keyword is in top N ranks).

14. The computer-readable storage medium according to claim 11, wherein the marking a hotspot region corresponding to the keyword according to the feature values comprises:
obtaining variances of the feature values of the keyword in the respective regions;
removing a region the variance less than a threshold, and obtaining descending ranks of the variances in remaining regions; and
marking the hotspot region corresponding to the keyword according to the descending rankings of the variances.

15. The computer-readable storage medium according to claim 11, wherein the obtaining data comprises removing crawler data, blacklisted user data, blacklisted IP data, data whose source being undetermined, and a long-tail keyword from the data.

16. A data processing device based on electronic commerce, comprising:
a processor; and
a memory having stored thereon instructions that when executed by the processor, cause the processor to carry out a data processing method, wherein the data processing method comprises:
obtaining data comprising user searching logs and logistics information;
obtaining descending ranks of region-based keyword weights according to the data;
obtaining feature values of a keyword in respective regions according to the descending ranks of the region-based keyword weights; and
marking a hotspot region corresponding to the keyword according to the feature values.

17. The data processing device according to claim 16, wherein the obtaining descending ranks of region-based keyword weights according to the data comprises:
obtaining a region-based keyword searching page-view (PV) according to the user searching logs;
obtaining a number of a region-based keyword-corresponding commodity according to the logistics information;
determining, for a region, a sum of a product of the region-based keyword-searching PV with a first coefficient and a product of the number of the region-based keyword-corresponding commodity with a second coefficient as a weight of the keyword in the region; and
removing the keyword with the weight lower than a threshold, and performing a region-based descending ranking on the keyword according to the weights.

18. The data processing device according to claim 16, wherein the obtaining feature values of a keyword in respective regions according to the descending ranks of the region-based keyword weights comprises:
obtaining descending ranks of total weights of regions;
obtaining descending ranks of the weights of the keyword in all the regions;
obtaining, for each of the regions, the keyword with the weight not only in top N ranks in the each of the regions but also in top xN ranks in all the regions, where N is a natural number and x is an expansion coefficient; and
calculating, for each of the keywords and each of the regions, the feature value as:
(the weight of the keyword in the region/the total weight of the region) * (a number of total regions/a number of regions in which the keyword is in top N ranks).

19. The data processing device according to claim 16, wherein the marking a hotspot region corresponding to the keyword according to the feature values comprises:
obtaining variances of the feature values of the keyword in the respective regions;
removing a region with the variance less than a threshold, and obtaining descending ranks of the variances in remaining regions; and
marking the hotspot region corresponding to the keyword according to the descending rankings of the variances.

20. The data processing device according to claim 16, wherein the obtaining data comprises removing crawler data, blacklisted user data, blacklisted IP data, data whose source being undetermined, and a long-tail keyword from the data.
